(19) United States
(12) Patent Application Publication
(10) Pub. No.: US 2013/0129162 A1
(43) Pub. Date: May 23, 2013

(54) Method of Executing Software Functions Using Biometric Detection and Related Electronic Device

(71) Applicants: Shian-Luen Cheng, Kaohsiung City (TW); Shih-Wei Chen, New Taipei City (TW); Wen-Jeng Fang, Taipei City (TW)

(72) Inventors: Shian-Luen Cheng, Kaohsiung City (TW); Shih-Wei Chen, New Taipei City (TW); Wen-Jeng Fang, Taipei City (TW)

(21) Appl. No.: 13/303,123

(22) Filed: Nov. 22, 2011

(51) Int. Cl. G06K 9/00

(52) U.S. Cl. 382/124

(57) ABSTRACT

A method of executing software functions on an electronic device having biometric detection includes receiving touch input from one or more fingers of a user on a fingerprint sensor of the electronic device and recognizing one or more fingerprints and recognizing a gesture in the received touch input. The method further includes performing a fingerprint comparison to compare the one or more recognized fingerprints to contents of a database, performing a gesture comparison to compare the recognized gesture to contents of the database, determining a matching software function according to results of the fingerprint comparison and the gesture comparison, and executing the matching software function.

### BACKGROUND

1. Technical Field

The invention relates to biometric detection in an electronic device, and more particularly, to a method of executing software functions according to detected biometric data and detected user gestures.

2. Description of the Conventional Art

In recent years, biometric data has become an important part of security services. Biometric data, such as fingerprint, face recognition, iris recognition, and so on can be used to uniquely identify people in a reliable way that is difficult to forge.

In the computing industry, many storage devices, computing devices, and communication devices have adopted biometric authentication in order to prevent unauthorized users from gaining access to critical data. A common form of biometric data used in electronic devices is fingerprint detection. Since fingerprint detecting circuits can now be made in a small chip-like form factor, fingerprint sensors can be included in a variety of modern electronic devices while still keeping the devices thin, light, and small.

Please refer to FIG. 1. FIG. 1 is a diagram showing a notebook computer 20 according to the prior art. The notebook computer 20 shown in FIG. 1 is a ThinkPad® brand notebook computer sold by Lenovo®. The notebook computer 20 contains a fingerprint sensor 22 for enabling biometric identification for authorized users of the notebook computer 20. An authorized user swipes his finger 24 across the fingerprint sensor 22. Once the user is recognized as an authorized user, the user is allowed to access data stored within the notebook computer 20.

Please refer to FIG. 2. FIG. 2 is a diagram showing a mobile phone 30 according to the prior art. The mobile phone 30 shown in FIG. 2 is a Motorola ATRIX™ mobile phone. The mobile phone 30 contains a fingerprint sensor 32 for enabling biometric identification for authorized users of the mobile phone 30. In order to access protected data on the phone, an authorized user swipes his finger across the fingerprint sensor 32. Once the user is recognized as an authorized user, the user is allowed to access data stored within the mobile phone 30.

Please refer to FIG. 3. FIG. 3 illustrates a screen 40 showing an example of using a fingerprint sensor to control a cursor on a computer according to the prior art. The screen 40 is taken from the BioExcess™ software solution sold by Egis Technology Inc. As shown in the illustration 48 in FIG. 3, a user can move a finger across a fingerprint sensor in order to move the cursor up, down, left, or right. The sensitivity of the sensor can be adjusted in a sensitivity meter 42, and the adjustment can be confirmed with an “OK” button 44 or can be canceled with a “Cancel” button 46. It should be noted that although the fingerprint sensor can be used as an input device in order to move the cursor, the fingerprint sensor does not actually need to sense a fingerprint in order to allow the user to move the cursor.

Despite the utility provided by the fingerprint sensors of the prior art, none of the fingerprint sensors allow personalized software functions to be executed based in part on recognition of fingerprints of registered users, thereby allowing each registered user to create personalized input commands.

### SUMMARY

It is therefore one of the primary objectives of the claimed invention to provide a method of executing software functions on an electronic device having biometric detection, and a related electronic device.

According to an exemplary embodiment of the claimed invention, a method of executing software functions on an electronic device having biometric detection is disclosed. The method includes receiving touch input from one or more fingers of a user on a fingerprint sensor of the electronic device and recognizing one or more fingerprints and recognizing a gesture in the received touch input. The method further includes performing a fingerprint comparison to compare the one or more recognized fingerprints to contents of a database, performing a gesture comparison to compare the recognized gesture to contents of the database, determining a matching software function according to results of the fingerprint comparison and the gesture comparison, and executing the matching software function.

According to another exemplary embodiment of the claimed invention, an electronic device having biometric detection is disclosed. The electronic device includes a fingerprint sensor receiving touch input from one or more fingers of a user, a memory, and a database stored in the memory, the database containing a listing of a plurality of fingerprints and a plurality of gestures and corresponding software functions. The electronic device also includes a processor recognizing one or more fingerprints and recognizing a gesture in the received touch input, performing a fingerprint comparison to compare the one or more recognized fingerprints to contents of a database, performing a gesture comparison to compare the recognized gesture to contents of the database, determining a matching software function according to results of the fingerprint comparison and the gesture comparison, and executing the matching software function.

According to yet another exemplary embodiment of the claimed invention, a method of defining software functions on an electronic device having biometric detection is disclosed. The method includes selecting an interactive function and providing touch input as a setting, the provided touch input comprising providing at least one fingerprint and performing a gesture on a fingerprint sensor of the electronic device. The method also includes saving the setting corresponding to the selected interactive function in a database of the electronic device.

It is an advantage that the present invention provides the ability to recognize fingerprints and gestures through a fingerprint sensor. Through the combination of the recognized fingerprints and recognized gestures, an authorized user can execute personalized software functions that the user has pre-defined. Therefore, not only can each gesture correspond to a different software function, but each gesture for each recognized fingerprint can also correspond to a different software function. In this way the present invention provides a highly adaptable and customizable platform for allowing authorized users to execute software functions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a notebook computer according to the prior art.

FIG. 2 is a diagram showing a mobile phone according to the prior art.

FIG. 3 illustrates a screen showing an example of using a fingerprint sensor to control a cursor on a computer according to the prior art.

FIG. 4 is a block diagram of an electronic device connected to a host according to the present invention.

FIG. 5 is a diagram illustrating controlling electronic devices using fingerprints and gestures recognized through the fingerprint sensor.

FIG. 6 is a flowchart illustrating the process of defining software functions in terms of corresponding fingerprints and gestures according to the present invention method.

FIG. 7 is a flowchart illustrating the process of executing software functions in the present invention according to detected fingerprints and gestures.

FIG. 8 is a screenshot showing a first example of unlocking a mobile phone using gesture and fingerprint recognition according to the present invention.

FIG. 9 is a screenshot showing a second example of unlocking a mobile phone using gesture and fingerprint recognition according to the present invention.

FIG. 10 shows a screenshot containing icons corresponding to a full set of applications stored on the mobile phone. Icons are located at a lower portion of the screen.

FIG. 11 shows a screenshot containing icons that correspond to a reduced set of applications stored on the mobile phone.

FIG. 12 is a diagram showing three different gestures and their matching software functions as set by two different users.

FIG. 13 is a diagram showing three gestures and available software functions that can be assigned to the gestures through the application software program of the present invention.

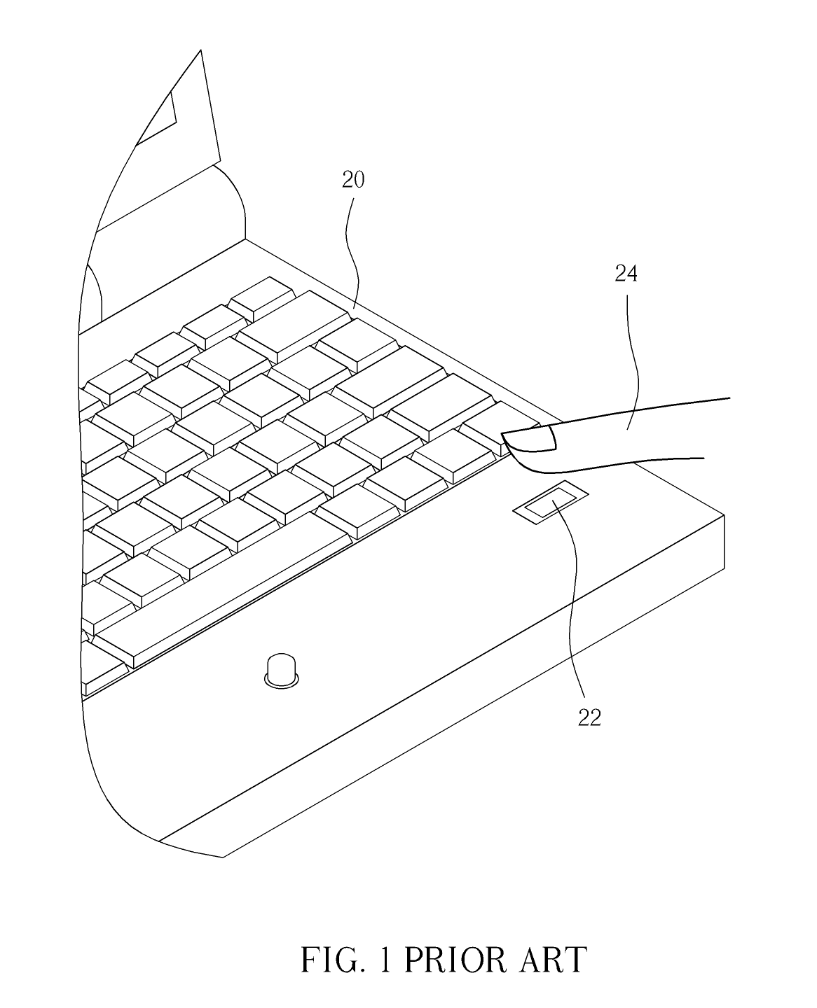

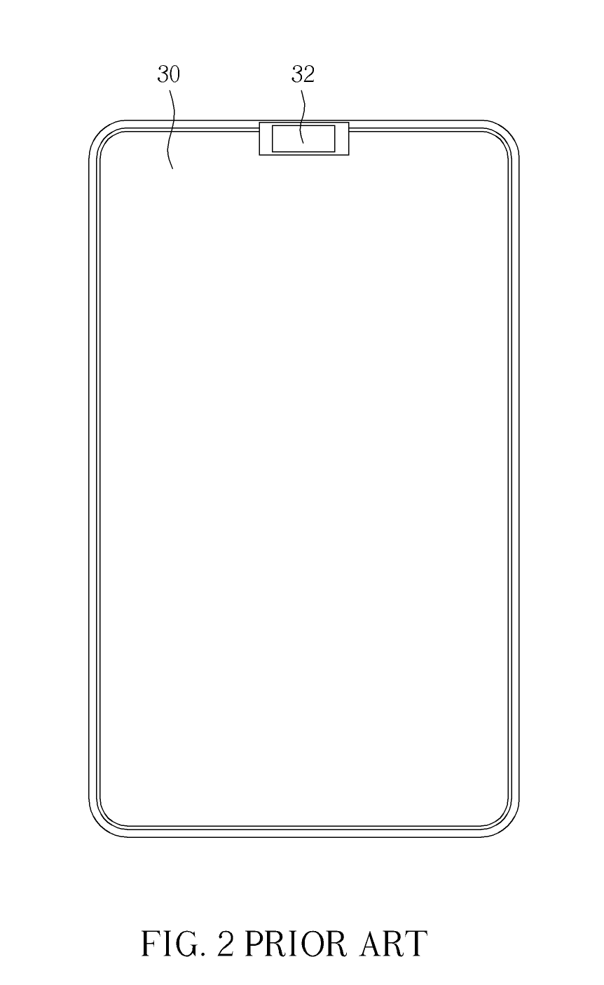

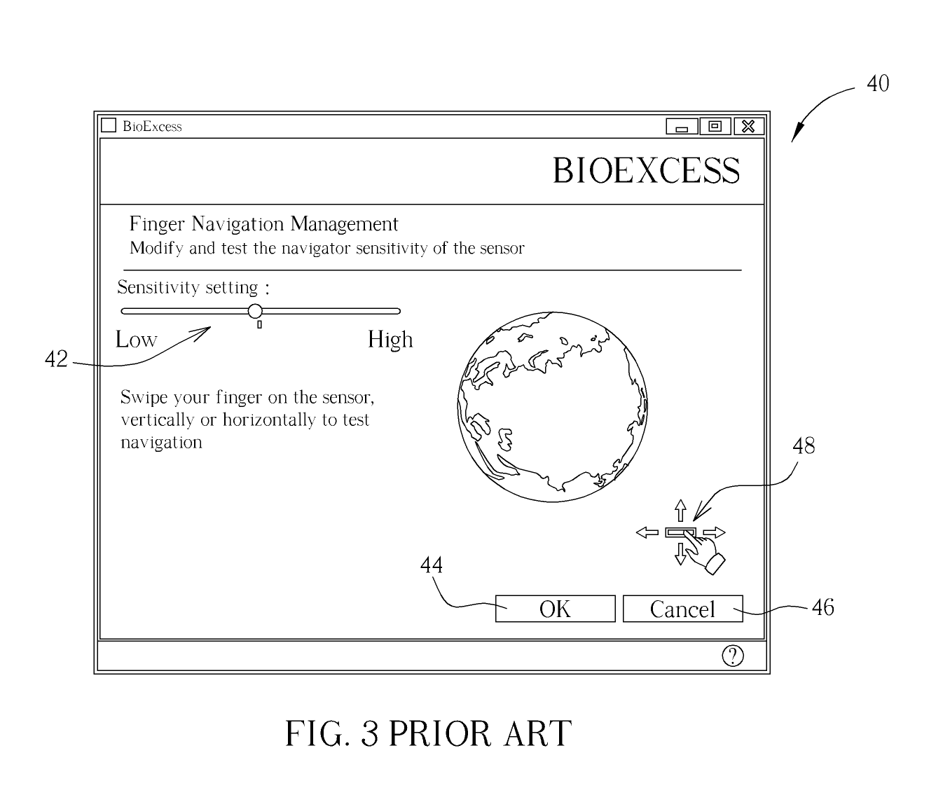

### DETAILED DESCRIPTION

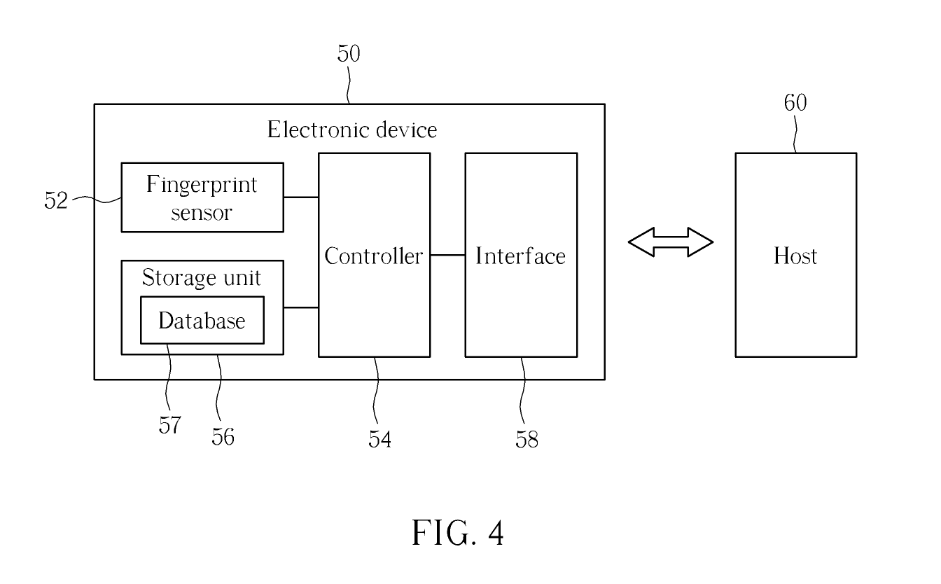

Please refer to FIG. 4. FIG. 4 is a block diagram of an electronic device 50 connected to a host 60 according to the present invention. The electronic device 50 contains a fingerprint sensor 52 for performing fingerprint recognition as well as for recognizing gestures performed by a user of the electronic device 50. A storage unit 56 may be used for storing user data, program data, as well as a database 57. The storage unit 56 can be any form of memory unit that has data storage ability. Preferably, the storage unit 56 is a form of non-volatile memory for retaining data even when power is not supplied to the electronic device 50. The storage unit 56 may be formed from flash memory, such as NAND flash memory.

The database 57 stores fingerprint data for one or more users of the electronic device 50, gestures defined by the users, and corresponding software functions that are to be executed when the fingerprint sensor 52 recognizes one or more fingerprints and a gesture corresponding to a matching software function stored in the database 57. A controller 54 compares the recognized fingerprints and gestures to the contents of the database 57 to look for a matching software function. When the controller 54 locates a matching software function, the controller 54 executes the matching software function.

The electronic device 50 may be a standalone electronic device 50 that can operate without a host, or the electronic device 50 may connect to the host 60 through an interface 58. For example, if the electronic device 50 connects to the host 60 through the interface 58, the interface 58 may be any kind of interface such as the universal serial bus (USB) interface or the external serial advanced technology attachment (eSATA) interface. The electronic device 50 may be any kind of electronic device, including a computer, a mobile phone, a storage device, and so on. The electronic device 50 may be portable or not. In short, any device having a fingerprint sensor and a storage unit storing a database of software functions is suitable for implementing the present invention. Thus, by using the fingerprint sensor 52, the electronic device 50 is able to use biometric identification for controlling the execution of matching software functions. On the other hand, the database 57 may also store commands corresponding to the recognized fingerprints and gestures. The commands are provided by the controller 54 to the host 60 for executing software functions stored in the host 60.

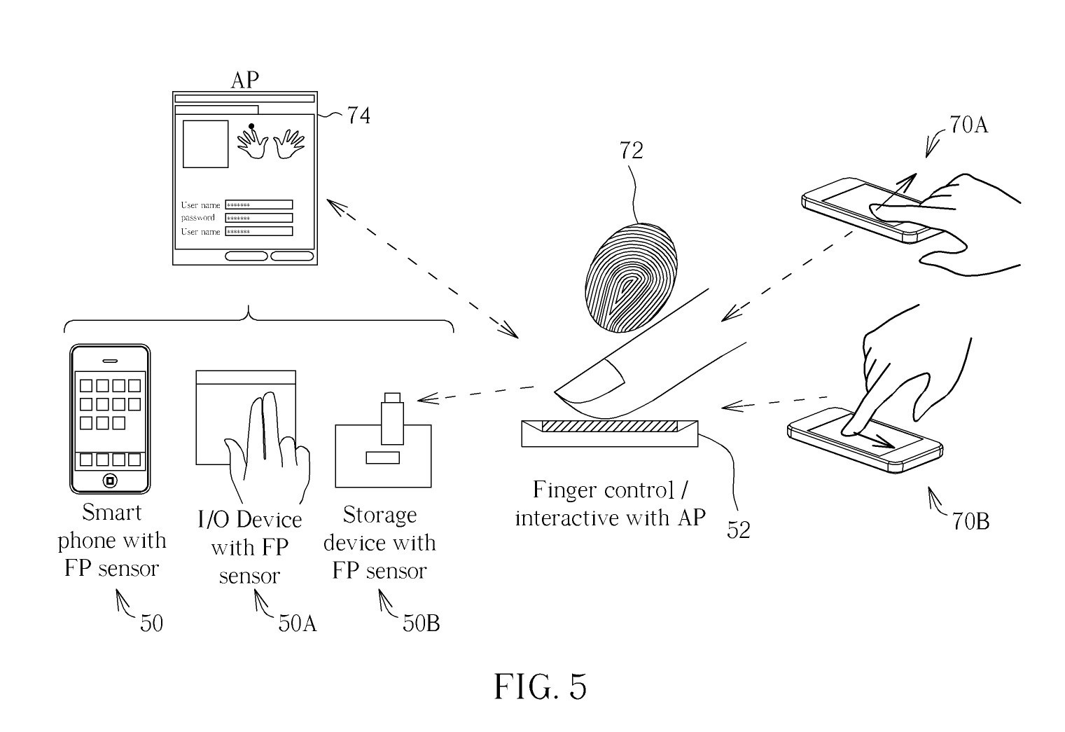

Please refer to FIG. 5. FIG. 5 is a diagram illustrating controlling electronic devices 50, 50A, and 50B using fingerprints 72 and gestures 70A and 70B recognized through the fingerprint sensor 52. Each of the electronic devices 50, 50A, and 50B contains a fingerprint sensor such as the fingerprint sensor 52. The electronic device 50 represents a smart phone, the electronic device 50A represents an input/output device, such as a track pad on a notebook computer, and the electronic device 50B represents a storage device such as a portable hard drive having a fingerprint sensor. For simplicity, the electronic device 50 will be taken as an example, although this is not intended to limit the present invention, which is capable of being implemented with any electronic device.

When a user wishes to control the electronic device 50A, the user can touch the fingerprint sensor 52 while making a gesture such as gesture 70A, representing a left-to-right swipe, or gesture 70B, representing a downward swipe. The gesture 70A will be taken as an example in this discussion. The fingerprint sensor 52 will detect not only the gesture 70A that was used, but also will detect at least one fingerprint 72 used with the gesture 70A. Once the gesture 70A and the fingerprint 72 have been detected, an application software program 74 determines a matching software function according to the database 57 stored in the storage unit 56 of the electronic device 50. After a match has been found, the application software program 74 executes the matching software function.

When the user touches the fingerprint sensor 52, the user can use either single-touch or multi-touch gestures. In the case of a single-touch gesture being used, the fingerprint sensor 52 detects the corresponding single fingerprint associated with the single-touch gesture. Since each of the user's fingers has a unique fingerprint, a different matching software function could be used for each finger. Furthermore, a different matching software function can also be programmed for each gesture. Therefore, a variety of different combinations of fingerprints and gestures can be used for programming and executing the matching software functions.

Multi-touch gestures work in much the same manner as single-touch gestures, with the fingerprint sensor 52 detecting multiple fingerprints instead of a single fingerprint. Not only does the combination of fingerprints used in the multi-touch gesture determine which matching software function is executed, but the sequence in which the multiple fingerprints are recognized can also be considered for determining the gesture type. For example, touching the fingerprint sensor 52 with the index finger before also touching the fingerprint sensor 52 with the middle finger could be considered to be a separate gesture than reversing the sequence of the fingers in order to touch the fingerprint sensor 52 with the middle finger before touching with the index finger. Using another combination of fingers could be considered as still other gestures.

Examples of simple gestures include swiping to the left, swiping to the right, swiping upward, swiping downward, and a sustained hold on the fingerprint sensor 52. Other more complicated gestures can also be used. Furthermore, the position at which touch input is received on the fingerprint sensor 52 can also be used for determining the gesture type. As mentioned above, the gestures can be a single-touch gesture with one detected fingerprint or can be multi-touch gestures with multiple detected fingerprints. A gesture can even be defined to include sequential motions instead of a single detected motion. In other words, a gesture can be defined as being a combination of multiple simple gestures.

Moreover, since each user has distinct fingerprints, each user can create their own customized matching software functions forgiven combination of recognized fingerprints and recognized gestures. Therefore, each user can be instantly recognized by the user's fingerprints and the user can execute their own matching software functions that have been previously set in the database 57 via the application software program 74.

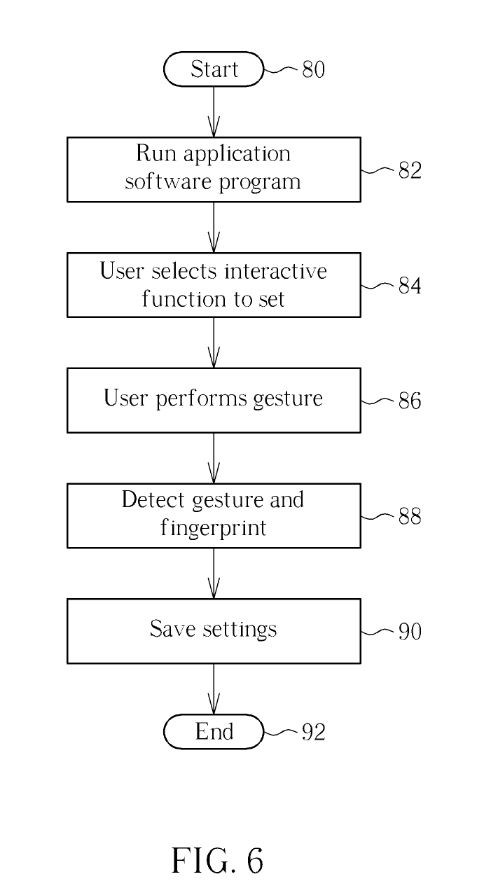

Please refer to FIG. 6. FIG. 6 is a flowchart illustrating the process of defining software functions in terms of corresponding fingerprints and gestures according to the present invention method. Steps contained in the flowchart will be explained below.

Step 80: Start.

Step 82: The user runs the application software program 74. If the electronic device 50 is to be connected to a host such as the host 60 shown in FIG. 4, the application software program 74 can be stored in either the electronic device 50 or in the host 60. The application software program 74 can be started manually by the user, or can be started automatically, such as when the host 60 detects a connection with the electronic device 50. If the electronic device 50 is a standalone device that operates without a host, then the application software program 74 can be started on the electronic device 50 directly.

Step 84: The user selects an interactive function to set. The interactive function is a software function that the user can define in terms of a corresponding fingerprint or fingerprints and a corresponding gesture. As an example, the user can choose to define the function of locking the electronic device 50. It should be noted that one, two, or more than two fingerprints can be used in the settings corresponding to the selected interactive function.

Step 86: The user performs a gesture on the fingerprint sensor 52 of the electronic device 50 in order to program the setting corresponding to the selected interactive function.

Step 88: The fingerprint sensor 52 detects not only the motion of the gesture, but also detects which fingerprint or fingerprints were used in the gesture. Furthermore, the sequence in which touch input was received corresponding to multiple fingerprints may be detected when multiple fingers are used.

Step 90: The gesture and fingerprint settings corresponding to the selected software function are saved. As a result, the database 57 contains an entry that defines the software function in terms of the associated fingerprints and gesture.

Step 92: End.

It should be noted that the sequence of step 84 to step 88 could be changed based on the design of the application software program 74. The user may perform a gesture on the fingerprint sensor 52 detected thereby first, and then select an interactive function to set. The sequence of detecting user's fingerprint and gesture, and setting the interactive function is not limited in this preferred embodiment.

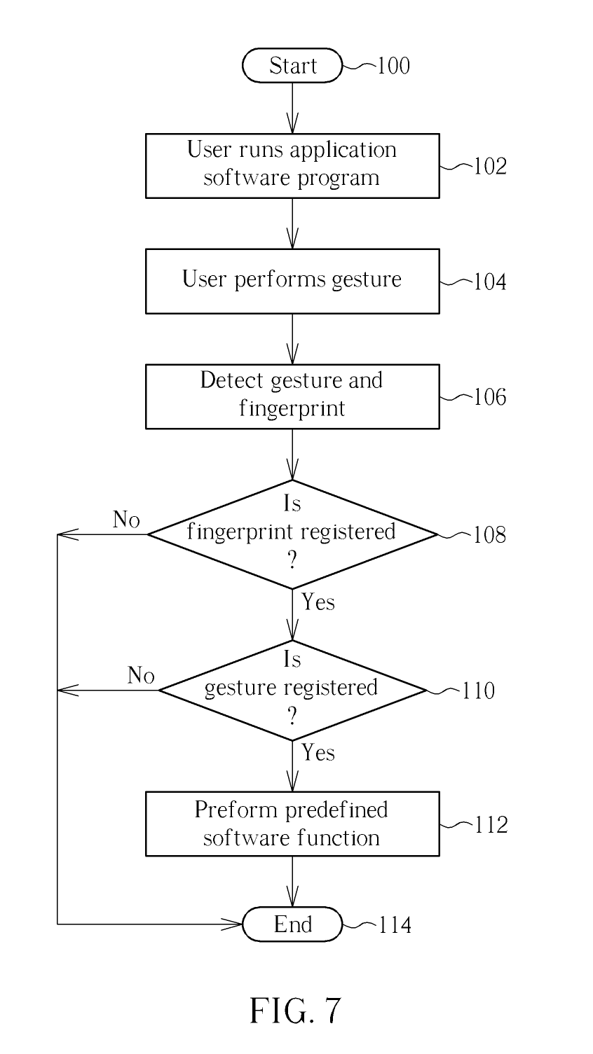

Please refer to FIG. 7. FIG. 7 is a flowchart illustrating the process of executing software functions in the present invention according to detected fingerprints and gestures. Steps contained in the flowchart will be explained below.

Step 100: Start.

Step 102: The user runs the application software program 74. If the electronic device is a standalone electronic device with an operating system, the application software 74 may be automatically executed in the background of the operating system when the user starts up the electronic device.

Step 104: The user performs a gesture on the fingerprint sensor 52 of the electronic device 50.

Step 106: The fingerprint sensor 52 detects the gesture as well as which fingerprint or fingerprints were used in the gesture.

Step 108: The application software program 74 determines if the detected fingerprint is registered in the database 57. If so, step 110 is followed. If not, step 114 is followed. This step serves to check whether the user is registered with the electronic device 50 because only registered users will have their fingerprints stored in the database 57.

Step 110: The application software program 74 determines if the detected gesture is registered in the database 57. If so, step 112 is followed. If not, step 114 is followed.

Step 112: The application software program 74 locates a matching software function corresponding to the detected fingerprint and gesture and executes the matching software function.

Step 114: End.

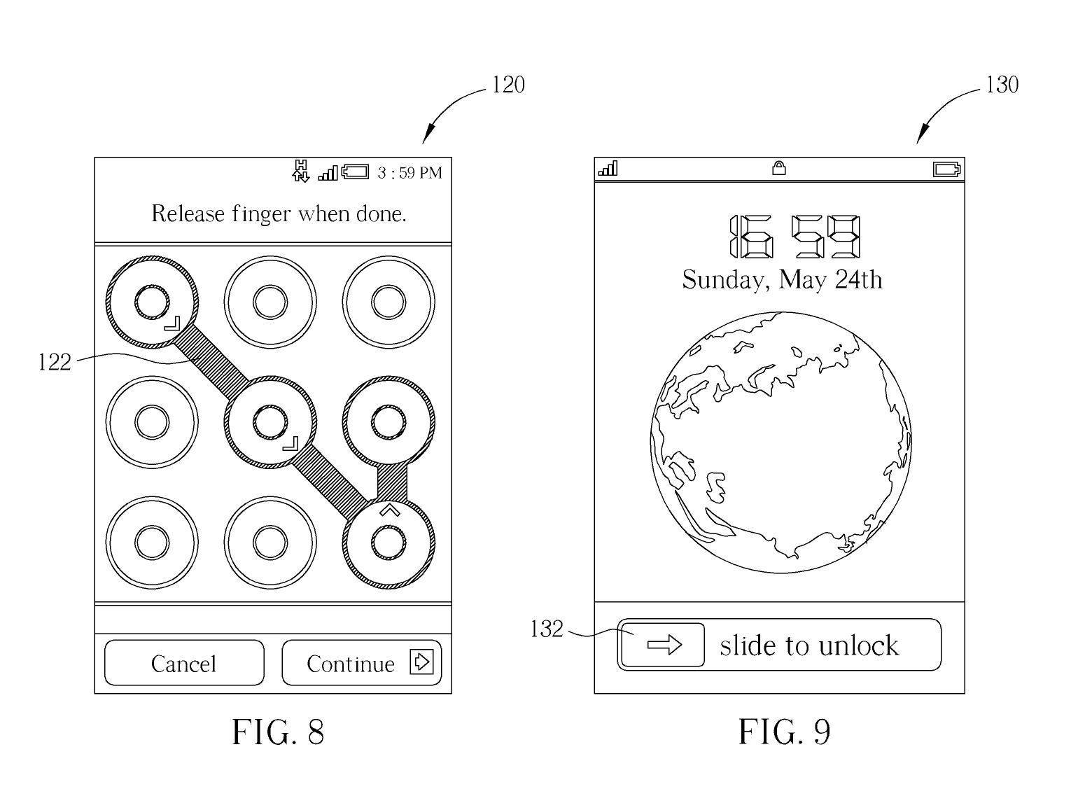

Please refer to FIG. 8. FIG. 8 is a screenshot 120 showing a first example of unlocking a mobile phone using gesture and fingerprint recognition according to the present invention. In order to unlock the mobile phone, the user must swipe his finger along the pattern 122 of dots shown. If the surface of the mobile phone that the user's finger is touching contains the fingerprint sensor 52 of the present invention, the fingerprint sensor 52 can detect not only the gesture performed by the user, but also the fingerprint of the finger touching the fingerprint sensor 52. If the user is an authorized user and if the gesture used is the correct gesture, the mobile phone will be unlocked. Otherwise, the mobile phone can remain locked.

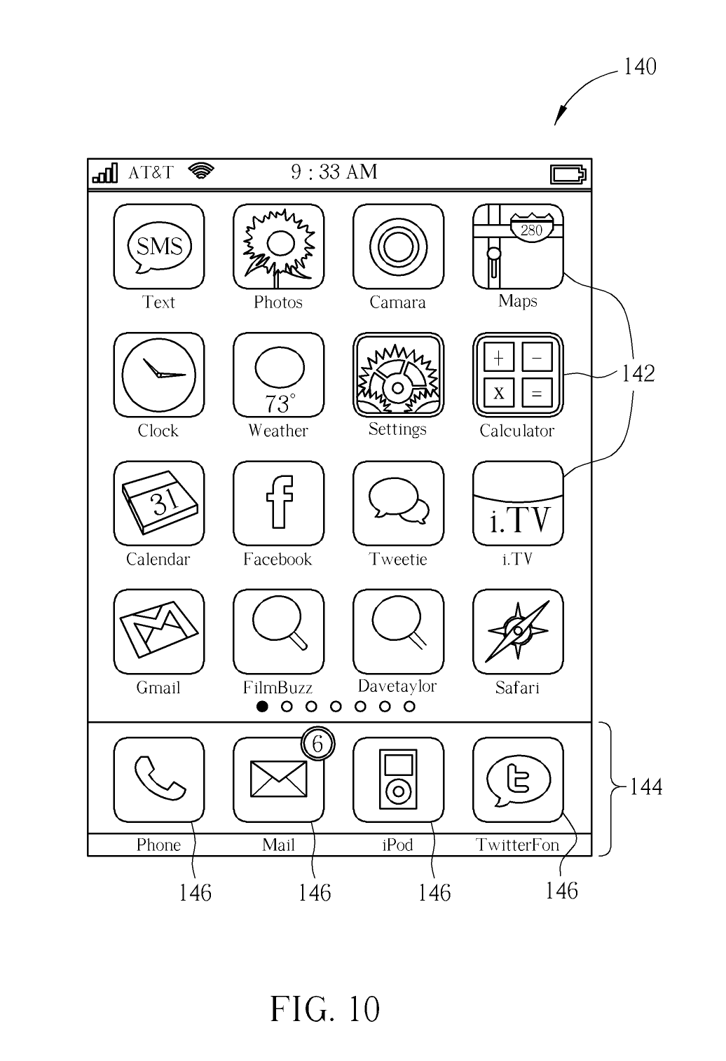

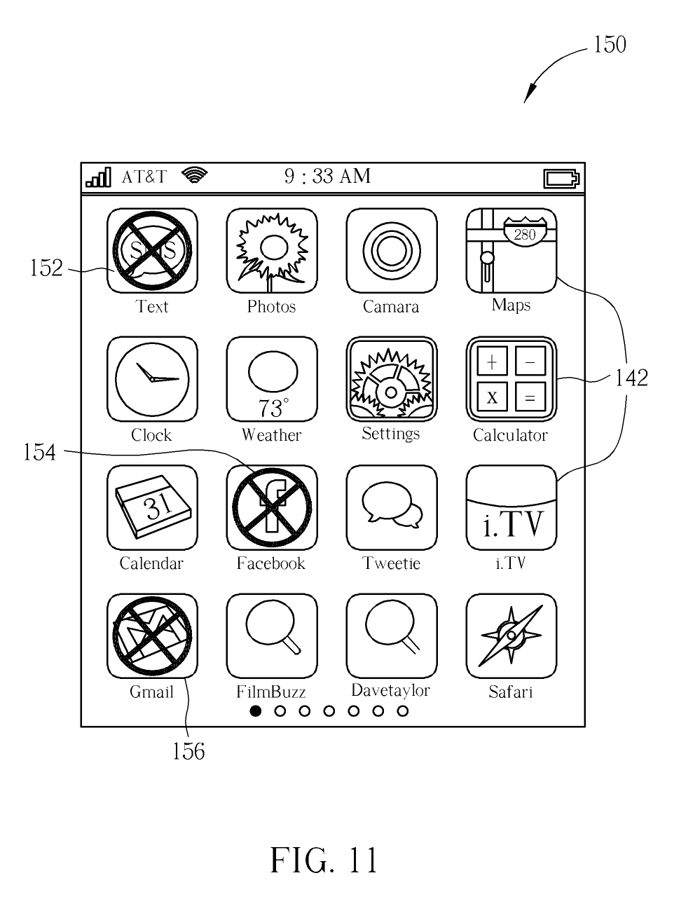

Please refer to FIG. 9. FIG. 9 is a screenshot 130 showing a second example of unlocking a mobile phone using gesture and fingerprint recognition according to the present invention. In order to unlock the mobile phone, the user must slide his finger from left to right along the arrow 132. As with the first example, if the surface of the mobile phone that the user's finger is touching contains the fingerprint sensor 52 of the present invention, the fingerprint sensor 52 can detect not only the gesture performed by the user, but also the fingerprint of the finger touching the fingerprint sensor 52. Depending on the settings of the mobile phone, different actions can be taken according to the identity of the user unlocking the phone. If the user is an authorized user and if the gesture used is the correct sliding gesture for unlocking the phone, the mobile phone will be unlocked and a full set of applications will be presented to the user, as shown in FIG. 10. Otherwise, if the user is not an authorized user and if the gesture used is the correct sliding gesture for unlocking the phone, the mobile phone will be unlocked and a reduced set of applications will be presented to the user, as shown in FIG. 11.

Please refer to FIG. 10 and FIG. 11. FIG. 10 shows a screenshot 140 containing icons 142 and 146 corresponding to a full set of applications stored on the mobile phone. Icons 146 are located at a lower portion 144 of the screen. FIG. 11 shows a screenshot 150 containing icons 142 that correspond to a reduced set of applications stored on the mobile phone. The applications shown in the screenshots 140 and 150 differ in that the reduced set of applications shown in screenshot 150 do not include the icons 146 at the lower portion of the screen 144. Furthermore, some of the icons 142 contained in the reduced set of applications have been crossed out to indicate that the user is not being given access to the corresponding applications. For instance, icon 152 corresponds to a short message service (SMS) text message application, icon 154 corresponds to a Facebook® application, and icon 156 corresponds to a Gmail® application. The applications corresponding to icons 152, 154, and 156 have been crossed out, indicating that the user of the mobile phone does not have access to these applications. Furthermore, each of the applications corresponding to the icons 146 shown in FIG. 10 are also unavailable to the user. Since the user is not an authorized user as determined according to the user's fingerprint read by the fingerprint sensor 52, the user is only shown a reduced set of applications that the user has access to. Thus, the user's identity determines what level of functionality is presented to the user.

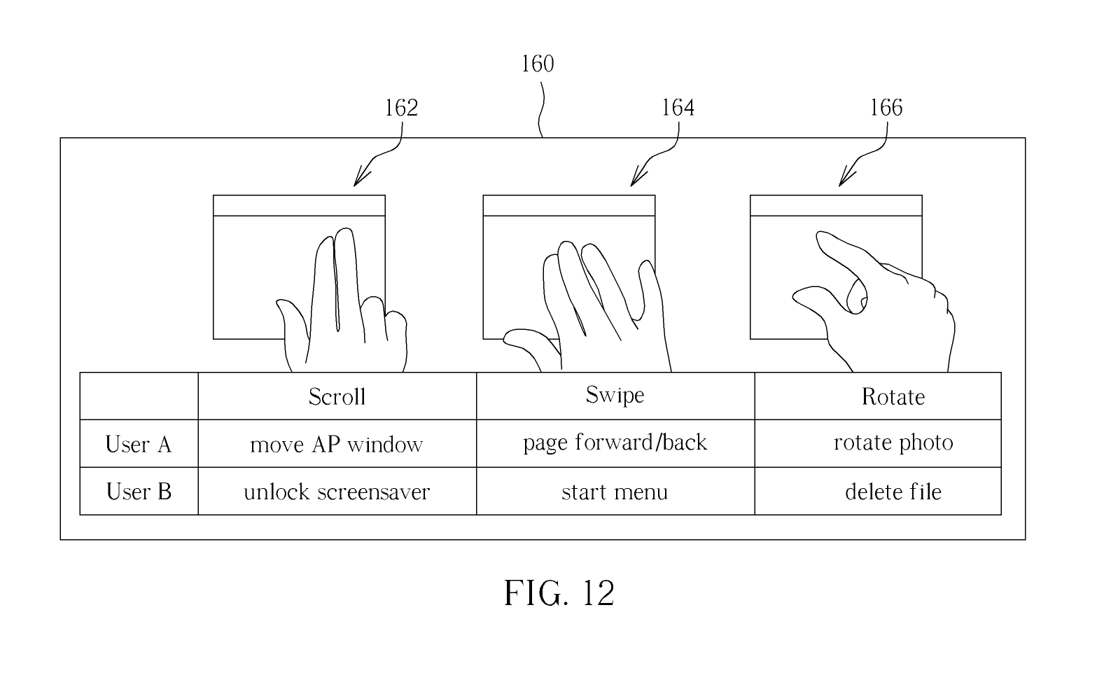

Please refer to FIG. 12. FIG. 12 is a diagram 160 showing three different gestures and their matching software functions as set by two different users. The type of gesture shown in gesture 162 is typically referred to as a scrolling gesture, the type of gesture shown in gesture 164 is typically referred to as a swiping gesture, and the type of gesture shown in gesture 166 is typically referred to as a rotating gesture. If there are two users of the electronic device 50, user A and user B, each user may customize matching software functions that are executed when the user performs the gestures 162, 164, or 166. For instance, user A may wish to set the scrolling gesture 162 to perform the action of moving the window of the application software program 74, whereas user B may wish to set the scrolling gesture 162 to perform the action of unlocking a screensaver of the electronic device 50. As another example, user A may wish to set the swiping gesture 164 to perform the action of moving a page forward or a page back, depending on the direction of the swiping gesture, whereas user B may wish to set the swiping gesture 164 to perform the action of opening a start menu of the electronic device 50. As a third example, user A may wish to set the rotating gesture 166 to perform the action of rotating a photo, whereas user B may wish to set the rotating gesture 166 to perform the action of deleting a file. A different matching software function can be set for each combination of user fingerprints and gestures, thereby providing users with great flexibility on customizing their user interface for the electronic device 50.

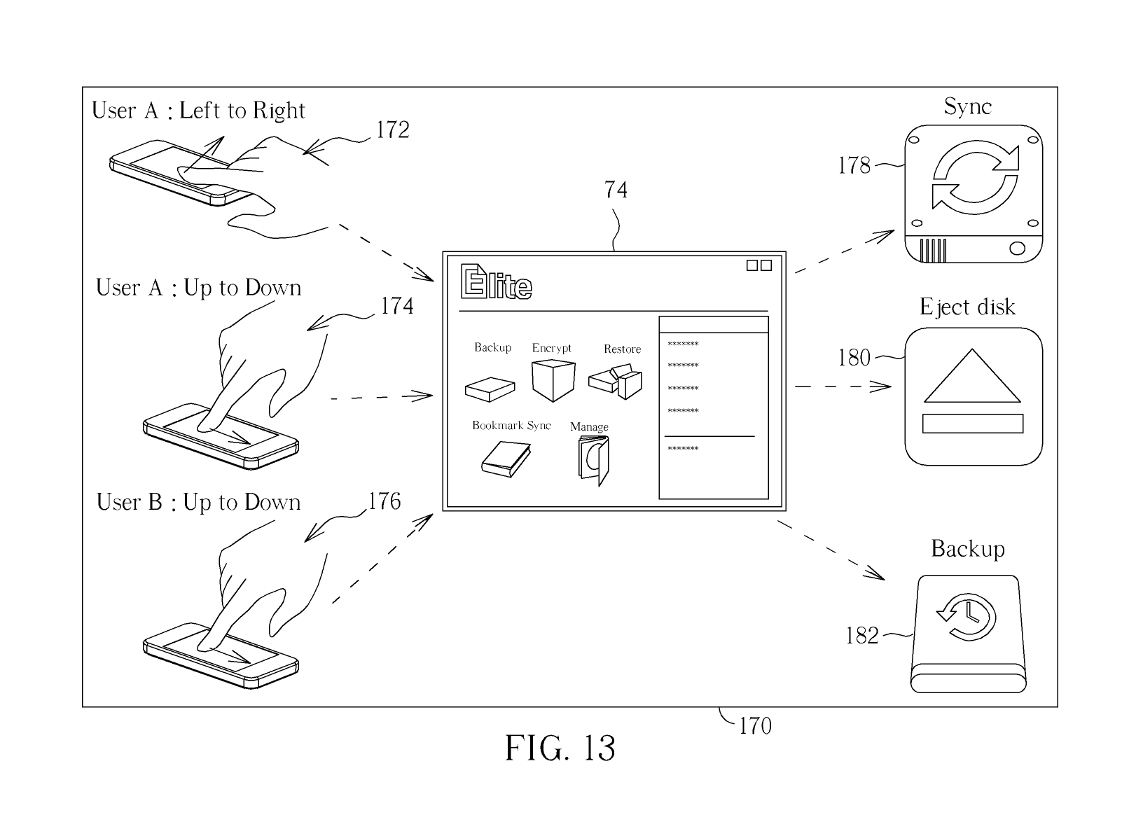

Please refer to FIG. 13. FIG. 13 is a diagram 170 showing three gestures 172, 174, and 176 and available software functions 178, 180, and 182 that can be assigned to the gestures through the application software program 74 of the present invention. Gesture 172 corresponds to a left to right sliding motion made by user A, gesture 174 corresponds to an up to down sliding motion made by user A, and gesture 176 corresponds to an up to down sliding motion made by user B. Although a large number of software functions could be assigned to the gestures 172, 174, and 176 through the application software program 74, only the available software functions 178, 180, and 182 are shown in FIG. 13 for simplicity. During the process of defining or setting software functions in terms of corresponding fingerprints and gestures shown in the flowchart of FIG. 6, the software functions corresponding to the gestures 172, 174, and 176 can be assigned.

In the prior art, each gesture could only be used for executing the same software function for each user. In contrast, the present invention provides a way for each user to define customized software functions to be performed when the user performs a gesture. This is possible because the user's fingerprints are detected as the gesture is performed.

In summary, the present invention provides the ability to recognize fingerprints and gestures through a fingerprint sensor. Through the combination of the recognized fingerprints and recognized gestures, an authorized user can execute personalized software functions that the user has pre-defined. Therefore, not only can each gesture correspond to a different software function, but each gesture for each recognized fingerprint can also correspond to a different software function. In this way the present invention provides a highly adaptable and customizable platform for allowing authorized users to execute software functions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of executing software functions on an electronic device having biometric detection, the method comprising:
receiving touch input from one or more fingers of a user on a fingerprint sensor of the electronic device;
recognizing one or more fingerprints and recognizing a gesture in the received touch input;
performing a fingerprint comparison to compare the one or more recognized fingerprints to contents of a database;
performing a gesture comparison to compare the recognized gesture to contents of the database;
determining a matching software function according to results of the fingerprint comparison and the gesture comparison; and
executing the matching software function.

2. The method of claim 1, wherein recognizing the one or more fingerprints comprises recognizing one fingerprint and recognizing the gesture comprises recognizing a single-touch gesture.

3. The method of claim 1, wherein recognizing the one or more fingerprints comprises recognizing two or more fingerprints and recognizing the gesture comprises recognizing a multi-touch gesture.

4. The method of claim 1, wherein recognizing the gesture comprises detecting one or more positions at which touch input was received on the fingerprint sensor.

5. The method of claim 1, wherein recognizing the one or more fingerprints comprises recognizing two or more fingerprints and recognizing the gesture comprises recognizing a sequence in which touch input corresponding to the two or more fingerprints is received.

6. The method of claim 1, wherein determining the matching software function according to results of the fingerprint comparison and the gesture comparison is performed on an application software program associated with the electronic device, and executing the matching software function comprises the application software program triggering execution of a software function in a host to which the electronic device is connected.

7. The method of claim 1, wherein the database contains a software function corresponding to each recognized fingerprint or fingerprint combination.

8. The method of claim 7, wherein the database contains a software function corresponding to each recognized fingerprint or fingerprint combination for each unique user registered in the database.

9. The method of claim 1, wherein the database contains a software function corresponding to each recognized gesture.

10. An electronic device having biometric detection, the electronic device comprising:
a fingerprint sensor receiving touch input from one or more fingers of a user, wherein the received touch input comprises at least one fingerprint and a gesture;
a memory;
a database stored in the memory, the database containing a listing of a plurality of fingerprints and a plurality of gestures and corresponding software functions; and
a processor recognizing the received touch input, performing a comparison to compare the received touch input to contents of the database, determining a matching software function according to results of the comparison, and executing the matching software function.

11. The electronic device of claim 10, wherein the processor recognizing the received touch input comprises recognizing one fingerprint and recognizing a single-touch gesture.

12. The electronic device of claim 10, wherein the processor recognizing the received touch input comprises recognizing two or more fingerprints and recognizing a multi-touch gesture.

13. The electronic device of claim 10, wherein the processor recognizing the received touch input comprises detecting one or more positions at which touch input was received on the fingerprint sensor.

14. The electronic device of claim 10, wherein the processor recognizing the received touch input comprises recognizing which finger or fingers of the user the one or more fingerprints correspond to.

15. The electronic device of claim 10, wherein the processor recognizing the received touch input comprises recognizing two or more fingerprints and recognizing a sequence in which touch input corresponding to the two or more fingerprints is received.

16. The electronic device of claim 10, wherein the processor determining the matching software function according to results of the received touch input comparison comprises the processor executing an application software program associated with the electronic device, and the processor executing the matching software function comprises the application software program triggering execution of a software function in a host to which the electronic device is connected.

17. The electronic device of claim 10, wherein the database contains a software function corresponding to each recognized received touch input.

18. The electronic device of claim 17, wherein the database contains a software function corresponding to each recognized received touch input for each unique user registered in the database.

19. The electronic device of claim 10, wherein the database contains a software function corresponding to each recognized gesture.

20. A method of defining software functions on an electronic device having biometric detection, the method comprising:
selecting an interactive function;
providing touch input as a setting, the provided touch input comprising providing at least one fingerprint and performing a gesture on a fingerprint sensor of the electronic device; and
saving the setting corresponding to the selected interactive function in a database of the electronic device.

21. The method of claim 20, wherein the step of providing touch input as a setting comprises providing two or more fingerprints and providing a sequence in which touch input corresponding to the two or more fingerprints.

22. The method of claim 20, wherein the database of the electronic device contains a software function corresponding to the setting.
